(19) United States
(12) Patent Application Publication
(10) Pub. No.: US 2016/0359783 A1
(43) Pub. Date: Dec. 8, 2016

(54) Utility Patent: Email Process that Violates Causality

(71) Applicant: Ricardo Tomas Gil, San Antonio, TX (US)

(72) Inventor: Ricardo Tomas Gil, San Antonio, TX (US)

(21) Appl. No.: 14/732,696

(22) Filed: Jun. 6, 2015

(51) Int. Cl. H04L 12/58

(52) U.S. Cl. CPC H04L 51/14

(57) ABSTRACT

Email Process that Violates Causality objective is to shorten the distance(0.5 meter fiber optic cable) which results in the message being accessible in a closed network or loop (fiber optic cable from computer A to computer A) in (x) amount of time or interval in space-time. In this case the message is accelerated at the speed of light and is accessible before the earth changes in space-time. Rate of message is at=299,792,458 m/s (speed of light)/change of space time of earth is 30,463 m/s(earth' orbit around sun and earth's rotation on it's axis)=9,841 m/s. 9,841 /(1 m)=9,841 seconds/60 seconds=164 minutes / 60 minutes =2.7 hours. 2.7 hours is the number of time the message is accessible or able to be sent back (theory).

### NO CROSS-REFERENCE TO ANY OTHER APPLICATION

### NO FEDERALLY SPONSORED RESEARCH

Not applicable.

Not applicable.

### BACKGROUND

Email Process that violates causality is email server is an email that violates causality(report on event) but not violate primitive causality(Can't change event). I have successfully sent a message back 1 minute on yahoo. (Documented).

### SUMMARY

Basically its teleportation except the goal is not to send the information over a long distance, the objective is to transmit the message at the speed of light back to and from the computer. The objective is to shorten the distance(0.5 meter fiber optic cable) which results in the message being accessible in a closed network or loop (fiber optic cable from computer A to computer A) in (x) amount of time or interval in space-time. In this case the message is accelerated at the speed of light and is accessible before the earth changes in space-time. Rate of message is at=299,792,458 m/s (speed of light)/ change of space time of earth is 30,463 m/s(earth' orbit around sun and earth's rotation on it's axis)=9,841 m/s. 9,841 /(1 m)=9,841seconds/60 seconds=164 minutes/60 minutes=2.7 hours. 2.7 hours is the number of time the message is accessible or able to be sent back (theory).

### DESCRIPTION OF DRAWING

FIG. 1 Email Process that Violates Causality Drawing has a keyboard, screen, mouse, printer, 2 Mellanox 100 gigabit fiber optic adapter, 100 gigabit fiber optic cable, and tower/server. The fiber optic cable goes out from the tower (computer) and loops back into to the computer.

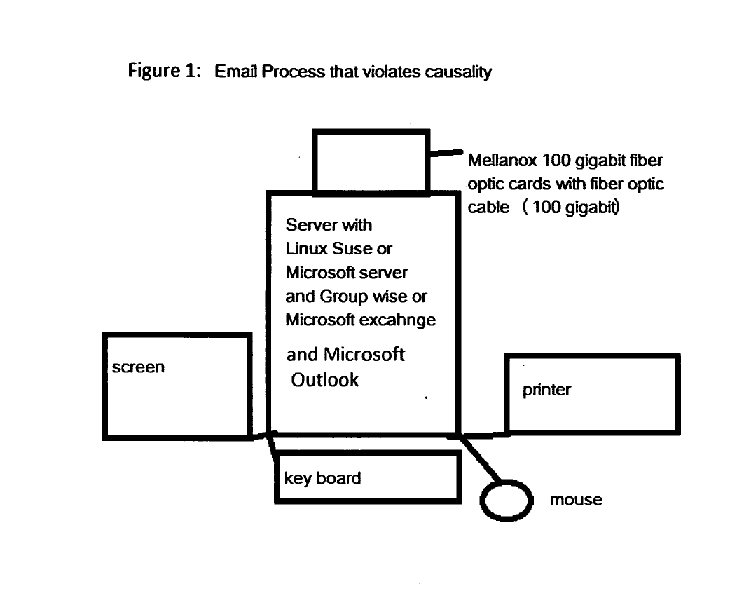

### DETAILED DESCRIPTION

The tower/server has Microsoft server, Microsoft exchange and Microsoft Outlook or Linux SUSE and Groupwise server with Groupwise. The email message is sent from ricardo.gil@sbcglobal.net to ricardo.gil@sbcglobal.net and accelerated through the fiber optic cable at the speed of light or time that equals faster than the speed of light because the cable is shortened.

1. When the message is sent it accelerates at the speed of light because it is a fiber optic connection from the computer to the computer, the message is traveling at the speed of light 299,792,458 m/s the message is 9,841 times faster than the change in space-time of the earth which is 30,463 m/s. The outcome is that the message theoretically should be accessible up to 2.7 hours.

2. If a message goes 299,792,458 m/s for 1 meter in a second in a vacuum it can travel 189,742,458 m/s (refractive speed of light in a fiber optic cable=299,792,458m/s/1.58=189,742,062 m/s) for 0.6 m for 1 second. Time will equal 0.000,000,003 seconds for both cases using (Time =Distance/Velocity). By reducing the distance to 0.6 m the message going 186,742,458 m/s in a fiber optic cable will arrive in the same amount of time as if it were going the speed of light in a vacuum 1 m. To go faster than the speed of light the length of the cable should be reduced to 0.5m which would be 379,484,916 m/s and arrive in 0.000,000,001 seconds. 379,484,916 m/s/30,463 m/s (change in space time)=12,457 m/s/60 sec=207 min/60 min=3.4 hrs. (up to 3.4 hrs Theory)

3. (Speed of Message)
*Argument or premise if a message goes 299,792,458 m/s for 1 meter in a second it can travel 189,742,062 m/s (refractive speed of light in a fiber optic cable) for 0.6 m for 1 second. Time will equal 0.000,000,003 seconds for both. By reducing the distance the message going 186,000,000 will arrive in the same amount of time as if it were going the speed of light in a vacuum.
**To go faster than the speed of light the length of the cable could be reduced to 0.5m which would be 372,000,000 m/s and arrive in 0.000,000,002 seconds.
Below are the cases using a simple proportion:
$$\frac{299 , 792 , 458 m \text{/} s}{189 , 742 , 062 m \text{/} s} = \frac{1 m}{.6 m ( cable )}$$
$$T = d / v .6 m / 189 , 742 , 062 m \text{/} s = .000 , 000 , 003 sec$$
$$\frac{379 , 484 , 124 m \text{/} s}{189 , 742 , 062 m \text{/} s} = \frac{1 m}{.5 m ( cable )}$$
$$T = d / v .5 m / 189 , 742 , 062 m \text{/} s = .000 , 000 , 002 sec$$
$$\frac{758 , 968 , 248 m \text{/} s}{189 , 742 , 062 m \text{/} s} = \frac{1 m}{.25 m ( cable )}$$
$$T = d / v .25 m / 189 , 742 , 062 m \text{/} s = .000 , 000 , 001 , 3 sec$$
$$\frac{1 , 897 , 420 , 620 m \text{/} s}{189 , 742 , 062 m \text{/} s} = \frac{1 m}{.1 m ( cable )}$$
$$T = d / v .1 m / 189 , 742 , 062 m \text{/} s = .000 , 000 , 000 , 52 sec$$
By reducing the cable length to 0.5 meters or less the message is traveling at 189,742,062 m/s the refractive speed of light, but the shortened distance of the cable allows for it to travel in the time as if the message were going faster than the speed of light.

4. (Calculation of Causality Time)
Argument: If a message goes 299,792,458 m/s for 1 meter in a second in a vacuum it can travel 189,742,458 m/s (refractive speed of light in a fiber optic cable=299,792,458m/s/1.58=189,742,062 m/s) for 0.6 m for 1 second. Time will equal 0.000,000,003 seconds for both cases using (Time=Distance/Velocity). By reducing the distance to 0.6 m the message going 186,742,458 m/s in a fiber optic cable will arrive in the same amount of time as if it were going the speed of light in a vacuum 1 m. To go faster than the speed of light the length of the cable should be reduced to 0.5m which would be 379,484,916 m/s and arrive in 0.000,000,002 seconds. 379,484,916 m/s / 30,463 ms=12,457 m/s/1 m(not the cable length, this is to get to seconds)=12,457 seconds/60 sec=207 min/60 min=3.4 hours. Change in space time is 463 m/s of the earth rotational axis alone but I have included the orbit of the earth around the sun 30,000 because the movement of the movement of the earth in a second is 30,463 m/s.

5. (Size of Message)
0.01 KB or 1 Word message (Example: 7:05)
$$\frac{75 KB}{.01 KB} = \frac{70000 words}{1 Word}$$
$$\frac{\begin{matrix}.01 KB = 0.000 , 000 , 076 , 293 , 945 , 3 gigabit ( 1 word ) = \\ ( .000 , 000 , 000 , 762 , 939 , 45 second )\end{matrix}}{100 gigabit} \frac{7.6293945 E \text{-} 10}{1 second}$$
$$.000 , 000 , 000 , 762 , 939 , 45 second = .5 / 655 , 360 , 002.684$$
$$.000 , 000 , 000 , 762 , 939 , 45 second = .4 / 524 , 288 , 002.147$$
$$.000 , 000 , 000 , 762 , 939 , 45 second = .3 / 393 , 216 , 001.611$$
